(19) United States
(12) Patent Application Publication
(10) Pub. No.: US 2010/0053039 A1
(43) Pub. Date: Mar. 4, 2010

(54) Display Device and Driving Method Thereof

(76) Inventors: Jong-Hwa Park, Seoul (KR); Kwang-Sub Shin, Anyang-si (KR); Byung-Sik Koh, Gwangmyeong-si (KR); Si-Duk Sung, Seoul (KR)

Correspondence Address: F. CHAU & ASSOCIATES, LLC, 130 WOODBURY ROAD, WOODBURY, NY, 11797, US

(21) Appl. No.: 12/547,154

(22) Filed: Aug. 25, 2009

(30) Foreign Application Priority Data
Sep. 1, 2008 (KR) 10-2008-0085860

(51) Int. Cl. G09G 3/30

(52) U.S. Cl. 345/76

(57) ABSTRACT

A display device includes a plurality of pixels respectively including a plurality of light-emitting elements, a comparing unit for comparing input image signals during a plurality of continuous frames for each pixel and determining whether the input image signals are repeated, a signal converter for converting the input image signal into a compensating image signal for the pixel where the input image signals are repeated during the continuous frames, and a data driver generating a data signal corresponding to the compensation image signal to supply the data signal to the pixel.

### CROSS-REFERENCE TO RELATED APPLICATION

This application claims priority to and the benefit of Korean Patent Application No. 10-2008-0085860 filed in the Korean Intellectual Property Office on Sep. 1, 2008, the contents of which are herein incorporated by reference in their entirety.

### BACKGROUND OF THE INVENTION

(a) Field of the Invention

The present disclosure is directed to a display device and a driving method thereof.

(b) Description of the Related Art

Recent trends toward lightweight and thin personal computers and television sets also require lightweight and thin display devices, and flat panel displays satisfying such requirements are being substituted for conventional cathode ray tubes (CRTs).

Flat panel displays include field emission displays (FED), plasma display panels (PDP), liquid crystal displays (LCD), etc.

In general, in an active type flat panel display, a plurality of pixels are arranged in a matrix form, and images are displayed by controlling the light strength of each pixel according to given brightness information. One type of active type flat panel display is an organic light emitting diode (OLED) display, which displays an image by electrically exciting a fluorescent organic material to emit light. The OLED display is a self-light-emitting type and has low power consumption and a rapid pixel response speed. Furthermore, an OLED can easily display a motion picture with a high image quality.

When displaying a motion picture with a high image quality, in the case that the same image is displayed for a predetermined time, an afterimage can remain in a region thereof.

### SUMMARY OF THE INVENTION

Embodiments of the present invention provide a display device and a driving method thereof where an afterimage is not retained after a same image is displayed for a predetermined time.

A display device according to an exemplary embodiment of the present invention includes: a plurality of pixels respectively including a plurality of light-emitting elements; a comparing unit comparing the input image signals during a plurality of continuous frames for each pixel, and determining whether the input image signals are repeated; a signal converter converting the input image signal into a compensating image signal for the pixel where the input image signals are repeated during continuous frames; and a data driver generating a data signal corresponding to the compensation image signal and supplying the data signal to the pixel.

The compensation image signal may include a black data that is periodically input to the input image signal.

The compensation image signal may input the input image signal after the input of the black data.

The comparing unit may include a plurality of first memories and second memories, and the first memories may respectively store the input image signal of one frame for the entire pixels and the second memories may store location information and the same input image signals of the pixel where the same input image signals are input.

The location information and the repeated input image signals of the pixel may be supplied from the second memory to the signal converter.

The comparing unit may transmit the input image signal of the pixel where the input image signals are different during the continuous frames to the data driver.

A driving method including a plurality of pixels having a plurality of light-emitting elements according to an exemplary embodiment of the present invention includes: storing input image signals for the pixels during a plurality of frames; determining whether the input image signals are repeated by comparing the stored input image signals for each pixel; generating a compensation image signal for the pixel where the input image signals are repeated during a plurality of continuous frames; and generating a data signal corresponding to the compensation image signal to supply the data signal to the pixel.

Generating the compensation image signal may include periodically inputting the black data signal to the input image signal.

The method may also include, after inputting the black data signal, again inputting the input image signal.

The method may also include storing location information and the input image signal of the repeated portion of pixels.

The method may also include generating a data signal corresponding to the input image signal and supplying the data signal to the pixel for the pixel where the input image signals are different during the continuous frames.

A display device according to another exemplary embodiment of the present invention includes a plurality of pixels displaying images, wherein, if image signals are repeated for a portion of pixels of the pixels during a plurality of frames, a black data signal is periodically input to the portion of pixels after the image signal, and a normal image signal is input to the remaining pixels.

The portion of pixels may be again supplied with a normal image signal after being periodically supplied with the black data signal.

According to an exemplary embodiment of the present invention, a pixel where the image signals are repeated during a plurality of frames is supplied with a black data to prevent retention of the afterimage even though the same image is displayed for a predetermined period.

### BRIEF DESCRIPTION OF THE DRAWINGS

FIG. 1 is a block diagram of an organic light emitting device according to an exemplary embodiment of the present invention.

FIG. 2 is an equivalent circuit diagram of one pixel in an organic light emitting device according to an exemplary embodiment of the present invention.

FIG. 3 is a cross-sectional view of a driving transistor and an organic light emitting element in one pixel of an organic light emitting device according to an exemplary embodiment of the present invention.

FIG. 4 is a schematic diagram of an organic light emitting element in an organic light emitting device according to an exemplary embodiment of the present invention.

FIG. 5 is a block diagram of a signal controller in an organic light emitting device according to an exemplary embodiment of the present invention.

FIG. 6 is a flowchart of a driving method of an organic light emitting device according to an exemplary embodiment of the present invention.

FIG. 7 is a photo showing an example of a portion where a same image signal is input during a predetermined frame.

FIG. 8 is a waveform diagram of an input signal in a driving method of an organic light emitting device according to an exemplary embodiment of the present invention.

### DETAILED DESCRIPTION OF EXEMPLARY EMBODIMENTS

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, like reference numerals designate like elements throughout the specification. It will be understood that when an element such as a layer, film, region, or substrate is referred to as being “on” another element, it can be directly on the other element or intervening elements may also be present.

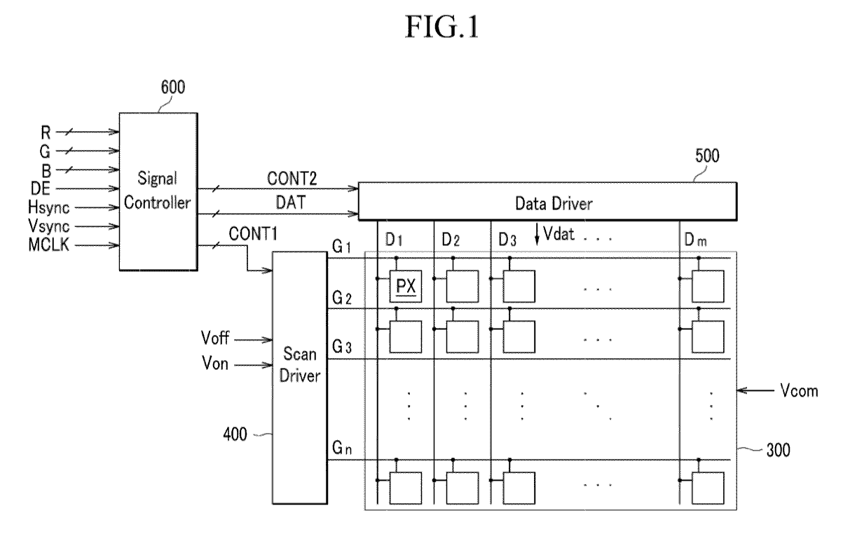

Firstly, an organic light emitting device according to an exemplary embodiment of the present invention will be described with reference to FIG. 1 to FIG. 4.

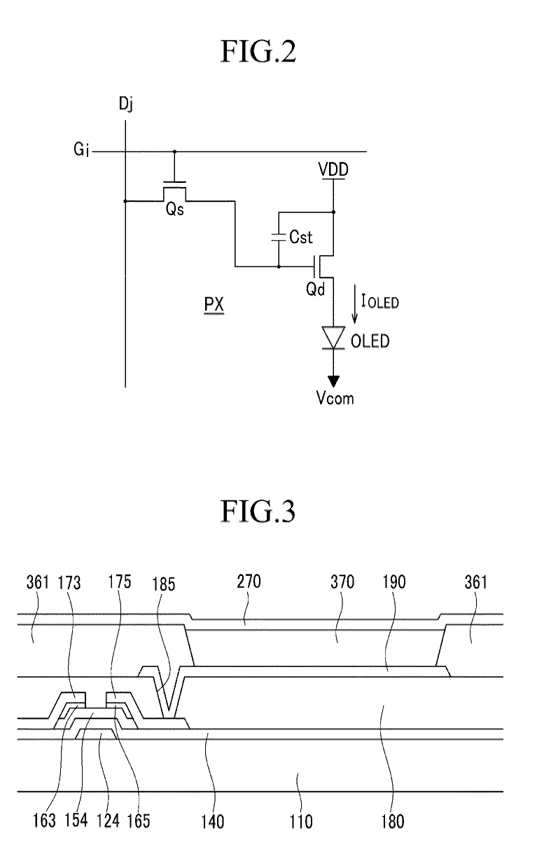

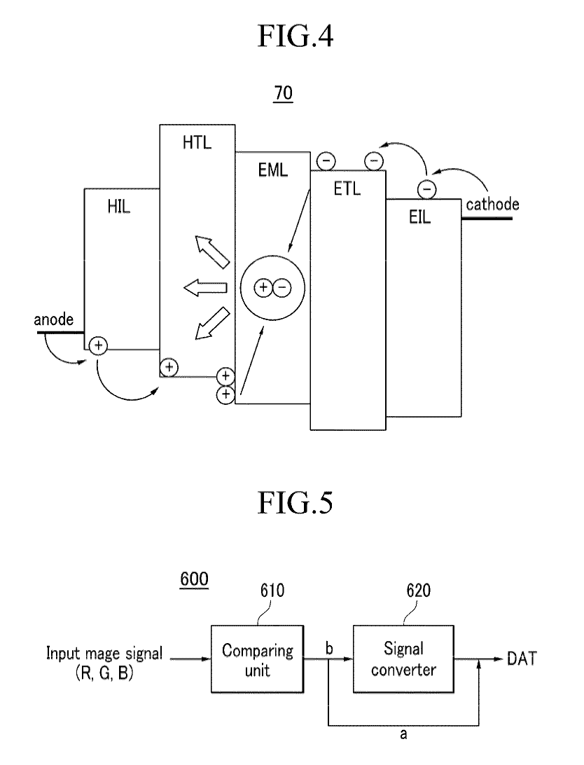

FIG. 1 is a block diagram of an organic light emitting device according to an exemplary embodiment of the present invention, FIG. 2 is an equivalent circuit diagram of one pixel in an organic light emitting device according to an exemplary embodiment of the present invention, FIG. 3 is a cross-sectional view of a driving transistor and an organic light emitting element in one pixel of an organic light emitting device according to an exemplary embodiment of the present invention, and FIG. 4 is a schematic diagram of an organic light emitting element in an organic light emitting device according to an exemplary embodiment of the present invention.

As shown in FIG. 1, an organic light emitting device according to an exemplary embodiment of the present invention includes a display panel 300, a scan driver 400 and a data driver 500 connected thereto, and a signal controller 600 for controlling them.

Referring to the equivalent circuit, the display panel assembly 300 includes a plurality of signal lines G1-Gn and D1-Dm and a plurality of pixels PX connected to the signal lines G1-Gn and D1-Dm and arranged substantially in a matrix structure.

The signal lines G1-Gn and D1-Dm include a plurality of gate lines G1-Gn transmitting scanning signals, and a plurality of data lines D1-Dm transmitting data signals. The gate lines G1-Gn extend substantially in a row direction and are substantially parallel to each other, and the data lines D1-Dm extend substantially in a column direction and are substantially parallel to each other.

As shown in FIG. 2, each pixel PX of the organic light emitting device according to an exemplary embodiment of the present invention includes an organic light emitting element OLED, a driving transistor Qd, a capacitor Cst, and a switching transistor Qs.

The control terminal of the driving transistor Qd is connected to the switching transistor Qs, the input terminal thereof is connected to the driving voltage VDD, and the output terminal thereof is connected to the organic light emitting diode OLED. The driving thin film transistor Qd outputs through the output terminal to the organic light emitting element OLED a current IOLED having a magnitude that changes according to a voltage between the control terminal and the output terminal of transistor Qd.

Each switching thin film transistor Qs has a control terminal, an input terminal, and an output terminal, and the control terminal thereof is connected to a gate line G1-Gn, the input terminal thereof is connected to a data line D1-Dm, and the output terminal thereof is connected to a driving thin film transistor Qd. The switching thin film transistor Qs transfers a data signal that is applied to the data line Dj to the driving thin film transistor Qd in response to a scanning signal that is applied to the gate line Gi.

The switching transistor Qs and the driving transistor Qd include an n-channel metal oxide semiconductor field effect transistor (MOSFET) comprising amorphous silicon. However, the transistors Qs and Qd may include a p-channel MOSFET, and in this case, because the p-channel MOSFET and the n-channel MOSFET are complementary, an operation, a voltage, and a current of the p-channel MOSFET are opposite to those of the n-channel MOSFET.

The capacitor Cst is connected between the control terminal and the input terminal of the driving thin film transistor Qd. The capacitor Cst charges the data voltages Vdat applied to the control terminal of the driving transistor Qd and maintains them during one frame.

The organic light emitting element OLED has an anode connected to the output terminal of the driving transistor Qd and a cathode connected to a common voltage Vcom. The organic light emitting element OLED emits light having an intensity depending on an output current IOLED of the driving transistor Qd.

Next, the structure of the driving transistor Qd and the organic light emitting element OLED of an organic light emitting device will be described with reference to FIG. 3 and FIG. 4.

FIG. 3 is a cross-sectional view of a driving transistor and an organic light emitting element in one pixel of an organic light emitting device according to an exemplary embodiment of the present invention, and FIG. 4 is a schematic diagram of an organic light emitting element in an organic light emitting device according to an exemplary embodiment of the present invention.

As shown in FIG. 3, a control electrode 124 is formed on an insulation substrate 110. The control electrode 124 may be made of an aluminum-based metal of aluminum (Al) or aluminum alloys, a silver-based metal of silver (Ag) or silver alloys, a copper-based metal of copper (Cu) or copper alloys, a molybdenum-based metal of molybdenum (Mo) or molybdenum alloys, chromium (Cr), tantalum (Ta), titanium (Ti), etc. However, the control electrode 124 may have a multi-layer structure including two conductive layers (not shown) that have different physical properties to each other. One of the conductive layers may be formed using a metal having low resistivity, such as an aluminum-based metal, a silver-based metal, or a copper-based metal, to reduce signal delay or voltage drop. Unlike the above, other conductive layers may be formed using a material having good physical, chemical, and electrical contact characteristics with, particularly, indium tin oxide (ITO) and indium zinc oxide (IZO), such as a molybdenum-based metal, chromium, tantalum, titanium, or the like. Examples of the combination may include a lower chromium film and an upper aluminum (alloy) film, and a lower aluminum (alloy) film and an upper molybdenum (alloy) film. However, the control electrode 124 may be made of various metals or conductors. Side surfaces of the control electrode 124 are inclined to a surface of the substrate 110, and an inclination angle thereof may be about 30° to about 80°.

A gate insulating layer 140, which is made of silicon nitride (SiNx), silicon oxide (SiOx), or so on, is formed on the control electrode 124.

A semiconductor island 154 that is made of hydrogenated amorphous silicon (a-Si), polysilicon, or so on, is formed on the gate insulating layer 140. A pair of ohmic contacts 163 and 165 is formed on the semiconductor island 154. The ohmic contacts 163 and 165 may be made of a material such as n+ hydrogenated amorphous silicon in which an n-type impurity such as phosphorus is doped with high concentration, or of silicide. The semiconductor island 154 and the ohmic contacts 163 and 165 are also inclined with respect to a surface of the substrate 110, and an inclination angle thereof is about 30° to about 80°.

An input electrode 173 and an output electrode 175 are formed on the ohmic contacts 163 and 165, and the insulating layer 140. The input electrode 173 and the output electrode 175 may be made of a refractory metal such as molybdenum, chromium, tantalum, and titanium, or alloys thereof, and have a multi-layered structure including a refractory metal layer (not shown) and a low resistance conductive layer (not shown). A multi-layered structure includes, for example, a dual-layer of a chromium or molybdenum (alloy) lower layer and an aluminum (alloy) upper layer, and a triple-layer of a molybdenum (alloy) lower layer, an aluminum (alloy) middle layer, and a molybdenum (alloy) upper layer. However, the input electrode 173 and the output electrode 175 may be made of various other metals or conductors. Side surfaces of the input electrode 173 and the output electrode 175 may also be inclined to the surface of the substrate 110, and an inclination angle thereof is about 30° to about 80°.

The input electrode 173 and the output electrode 175 are separated from each other and are disposed on the other side with respect to the control electrode 124. The control electrode 124, the input electrode 173, and the output electrode 175 form the driving transistor Qd along with the semiconductor 154, and the channel thereof is formed in the semiconductor 154 between the input electrode 173 and the output electrode 175.

The ohmic contacts 163 and 165 are interposed only between the underlying semiconductor island 154 and the overlying input electrode 173 and output electrode 175 thereon, and reduce contact resistance therebetween. The semiconductor islands 154 include exposed portions that are not covered by the input electrode 173 and the output electrode 175.

A passivation layer 180 is formed on the input electrode 173, the output electrode 175, and the exposed semiconductor 154. The passivation layer 180 may be made of an inorganic insulator or an organic insulator and may have a flat surface. The example of the inorganic insulator may be silicon nitride or silicon oxide. The organic insulator may have photosensitivity and the dielectric constant thereof may be less than about 4.0. Also, the passivation layer 180 may have a dual-layered structure of a lower inorganic layer and an upper organic layer to prevent damage to the exposed portions of the semiconductors 154 while maintaining insulating characteristics of the organic layer. The passivation layer 180 has a contact hole 185 exposing the output electrode 175.

A pixel electrode 190 is formed on the passivation layer 180. Each respective pixel electrode 190 is physically and electrically connected to an output electrode 175 through a contact holea 185, and may be made of a transparent conductive material such as ITO or IZO, or a reflective conductor such as silver, aluminum, or alloys thereof.

Partitions 361 are formed on the passivation layer 180. The partitions 361 define a plurality of openings enclosing edges of the pixel electrodes 190 like a bank, and are made of an organic insulator or an inorganic insulator.

An organic light emitting member 370 is formed in the opening defined by the partitions 361 on the pixel electrodes 190.

As shown in FIG. 4, the organic light emitting member 370 has a multi-layer structure including an auxiliary layer for improving light emitting efficiency of an emitting layer EML in addition to the emitting layer EML. The auxiliary layer includes an electron transport layer ETL and a hole transport layer HTL for adjusting the balance of electrons and holes, and an electron injecting layer EIL and a hole injecting layer HIL for solidifying the injection of electrons and holes. The accessory layers may be omitted.

The common electrode 270 is formed on the partition 361 and the organic light emitting member 370. The common electrode 270 is applied with a common voltage Vcom and is made of a transparent conductive material such as ITO or IZO or a reflective metal including calcium (Ca), barium (Ba), aluminum (Al), magnesium (Mg), aluminum, and silver (Ag).

The pixel electrode 190, the organic light emitting member 370, and the common electrode 270 comprise the organic light emitting diode OLED shown in FIG. 2, and the pixel electrode 190 can be an anode and the common electrode 270 can be a cathode, or the pixel electrode 190 can be a cathode and the common electrode 191 can be an anode. The organic light emitting diode OLED emits light of one primary color according to a material of the organic light emitting member 370. The primary color may include, for example, three primary colors of red, green, and blue, and a desired color may be displayed with a spatial combination of the three primary colors.

This organic light emitting device emits light toward the upper side of the substrate 110 to display images. An opaque pixel electrode 190 and a transparent common electrode 270 are applied to a top emission organic light emitting device for displaying an image in an upper direction of the display panel 300, and a transparent pixel electrode 190 and an opaque common electrode 270 are applied to a bottom emission organic light emitting device for displaying an image in a lower direction of the display panel 300.

Referring to FIG. 1, the gate driver 400 is connected to the gate lines G1 to Gn of the display panel 300, and applies scanning signals obtained by combining a gate-on voltage Von for turning on the switching elements Qs and a gate-off voltage Voff for turning them off to the gate lines G1 to Gn.

The data driver 500 is connected to the data lines D1 to Dm of the display panel 300, and applies the data voltages representing image signals to the pixels.

The gate driver 400 or the data driver 500 may be integrated on and mounted in the display panel 300 in the form of at least one IC chip, or may be mounted on a flexible printed circuit film (not shown) and attached to the liquid crystal panel assembly 300 in a tape carrier package (TCP). Alternatively, the driving apparatuses 400 and 500 may be integrated with the display panel 300.

The signal controller 600 controls the operations of the scan driver 400 and the data driver 500, and compensates the image signals.

Next, the operation of the organic light emitting device will be described.

The signal controller 600 receives input image signals R, G, and B, and an input control signal to control the display of the image signals R, G, and B from a graphics controller (not shown), and examples of the input control signals may include a vertical synchronization signal Vsync, a horizontal synchronizing signal Hsync, a main clock signal MCLK, a data enable signal DE, and the like. The signal controller 600 processes the input image signals R, G, and B in such a way to be suitable for the operating conditions of the display panel 300 based on the input image signals R, G, and B and the input control signal. The signal controller 600 generates a gate control signal CONT1, a data control signal CONT2, and so on, and it sends the gate control signal CONT1 to the scan driver 400 and the data control signal CONT2 and a processed image signal DAT to the data driver 500.

The gate control signal CONT1 includes a scanning start signal (STV) to initiate scanning, and at least one clock signal to control an output cycle of the gate-on voltage Von.

The data control signal CONT2 includes a horizontal synchronization start signal (STH) to indicate the start of image data transmission for a row of pixels (PX), a load signal (LOAD) to apply the data signal to the data lines (D1-Dm), and a data clock signal (HCLK).

The data driver 500 sequentially receives image data DAT for the pixels of one row according to the data control signal CONT2 from the signal controller 600, shifts them, and applies the data voltages corresponding to each image data DAT to the corresponding data lines D1 to Dm.

The scan driver 400 applies the gate-on voltage Von to the gate lines G1 to Gn according to the gate control signal CONT1 from the signal controller 600 to turn on the switching elements Qs connected to the gate lines G1 to Gn. Then, the data voltage that is applied to the data lines D1 to Dm is applied to the corresponding control terminal of the driving transistor Qd and the capacitor Cst through the turned-on switching elements Qs, and the capacitor Cst charges the data voltages. The voltage charged to the capacitor Cst is sustained during one frame, even though the scanning signal becomes the gate-off voltage Voff, thereby turning off the switching transistor Qs such that the control terminal voltage of the driving transistor Qd is uniformly maintained.

The driving transistor Qd outputs the output current IOLED, whose value depends on the data voltage, to the organic light emitting element OLED, and the organic light emitting element OLED emits with a strength that changes according to the magnitude of the driving current IOLED thereby displaying the corresponding image.

When one horizontal period (or 1H) (one period of the horizontal synchronization signal Hsync and the data enable signal DE) lapses, the data driver 500 and the scan driver 400 perform the same operation repeatedly over the next row of pixels. In this manner, the scan signals are sequentially applied to every scan signal line G1-Gn during one frame period to thus apply the data voltage to every pixel.

Next, an image signal compensation driving method of a signal controller of the organic light emitting device according to an exemplary embodiment of the present invention will be described with reference to FIG. 5 to FIG. 8.

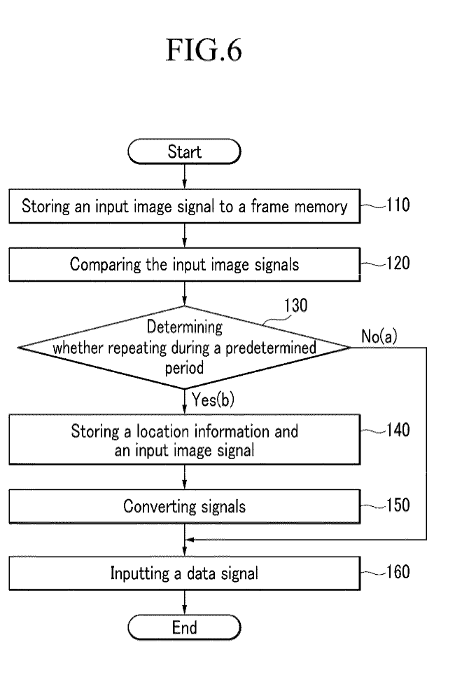

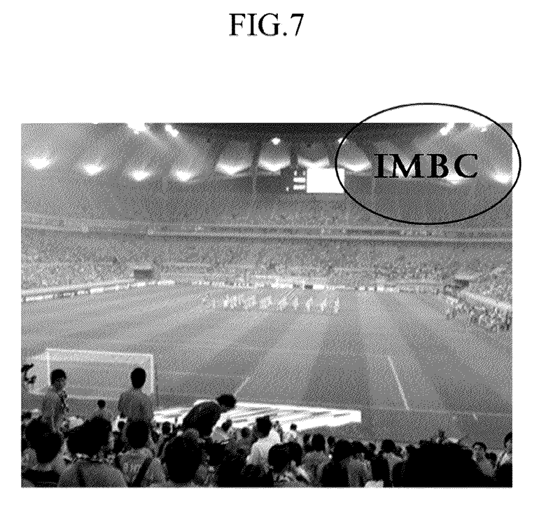

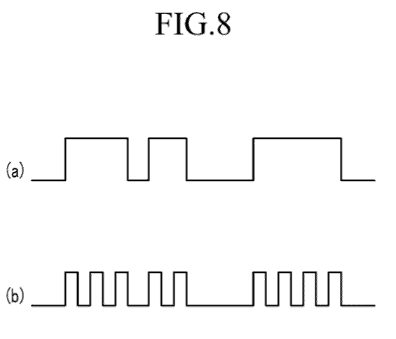

FIG. 5 is a block diagram of a signal controller in an organic light emitting device according to an exemplary embodiment of the present invention, FIG. 6 is a flowchart of a driving method of an organic light emitting device according to an exemplary embodiment of the present invention, FIG. 7 is a photo showing an example of the portion where a same image signal is input during a predetermined frame, and FIG. 8 is a waveform diagram of an input signal in a driving method of an organic light emitting device according to an exemplary embodiment of the present invention.

An image signal compensation method of the signal controller 600 shown in FIG. 5 will be described with reference to FIG. 5 and FIG. 6.

As shown in FIG. 5, the signal controller 600 includes a comparing unit 610 and a signal converter 620. Although not shown in the drawings, the comparing unit 610 includes a plurality of frame memories (not shown) and assistance memories (not shown).

Referring to FIG. 5 and FIG. 6, the comparing unit 610 stores the input image signals R, G, and B, which are input every frame, to each frame memory (step 110). The comparing unit 610 compares the input image signal R, G, and B, which is stored in each frame memory, to each other (step 120) to determine whether the same input image signal R, G, and B is supplied during the predetermined frame (step 130). Here, in each pixel, the input image signal R, G, and B which is supplied to the frame is compared and it is determined whether the input image signal R, G, and B is repeated during a plurality of frames for each pixel.

If a different image signal R, G, and B is supplied during the predetermined frames (a), the signal controller 600 directly processes the input image signal R, G, and B and outputs the image signal DAT to the data driver 500 (step 160).

If the same image signal R, G, and B is supplied (b), the location information and the input image signal R, G, and B of the (m×n) portion of pixels where the input image signal R, G, and B is repeated among the pixels are stored to an assistance memory (not shown) (step 140). Here, the assistance memory does not store the signals for all pixels, but only the information related to the (m×n) portion of pixels where the input image signal R, G, and B is repeated, such that the capacity thereof may be smaller than that of the frame memory.

The comparing unit 610 transmits to the signal converter 620 the stored location information and the input image signal R, G, and B of the m×n portion of pixels where the input image signal R, G, and B is repeated. The signal converter 620 converts the input image signal R, G, and B of the m×n portion of pixels (step 150) to generate a compensation image signal and transmits it as the image signal DAT (step 160).

Similarly, the signal converter 620 converts the image signal R, G, and B of the m×n pixel portion that is repeated during the predetermined frame of the input image signal R, G, and B to generate the compensation image signal to prevent the afterimage due to the repeat of the image signal. The comparing unit 610 of the signal controller 600 determines the m×n portion of pixels that is repeated during the predetermined frame of the input image signal R, G, and B, not the entire frame, and converts the signal, obtaining faster processing.

Next, the signal conversion of the signal converter 620 will be described with reference to FIG. 7 and FIG. 8. FIG. 7 is a photo showing an example of the portion where image signal is repeated during a predetermined frame, and FIG. 8 is a waveform diagram of an input signal in a driving method of an organic light emitting device according to an exemplary embodiment of the present invention.

Referring to FIG. 7, the logo of the broadcasting company is an example of a portion where the images are displayed for a predetermined period of the time among the entire screen when the motion picture is displayed. In FIG. 7, a circle indicates the portion where the images are repeated. The input image signal R, G, and B for the pixel portions that are repeated is repeatedly input during the predetermined period of time, as shown in FIG. 8(a). The signal converter 620 of the organic light emitting device according to an exemplary embodiment of the present invention receives the location information and the input image signal R, G, and B of the m×n portion of pixels that are repeated during the predetermined period of time. This is shown in FIG. 8(a) which corresponds to the circled portion of FIG. 7. The signal converter 620 then inserts black data to the input image signal R, G, and B to convert the signal, as shown in FIG. 8(b). This black data may be a data signal for temporarily turning off the current in the organic light emitting member 370. Accordingly, the image signal for the m×n portion of pixels that is supplied to the data driver after passing the signal converter 620 includes normal data based on the input image signal R, G, and B and the black data with minimal luminance.

As described, black data is inserted to the repeated input image signal R, G, and B with a predetermined period to prevent the signals from being continuous during the several frames, thereby preventing screen afterimages.

As described, according to embodiments of the present invention, the portion of pixels where the data signals are repeated during the predetermined frame is determined, and black data signal is inserted to the data signal of the repeated pixel portions to quickly prevent afterimages using little memory.

While embodiments of the invention have been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of pixels respectively comprising a plurality of light-emitting elements;
a comparing unit comparing input image signals during a plurality of continuous frames for each pixel, and determining whether the input image signals are repeated;
a signal converter converting the input image signal into a compensating image signal for a pixel where the input image signals are repeated during the continuous frames; and
a data driver generating a data signal corresponding to the compensation image signal and supplying the data signal to the pixel.

2. The display device of claim 1, wherein:
the compensation image signal comprises a black data that is periodically input to the input image signal.

3. The display device of claim 2, wherein:
the compensation image signal inputs the input image signal after the input of the black data.

4. The display device of claim 1, wherein:
the comparing unit comprises a plurality of first memories and second memories, wherein
the first memories respectively store the input image signal of one frame for all pixels, and
the second memories store location information and the input image signals of the pixel where the input image signals are repeated.

5. The display device of claim 4, wherein:
the location information and the repeated input image signals of the pixel are supplied from the second memory to the signal converter.

6. The display device of claim 4, wherein:
the compensation image signal comprises a black data that is periodically input to the input image signal.

7. The display device of claim 1, wherein:
the comparing unit transmits the input image signal of the pixel where the input image signals are different during the continuous frames to the data driver.

8. A method for driving a display device comprising a plurality of pixels respectively comprising a plurality of light-emitting elements comprising:
storing input image signals for the pixels during a plurality of frames;
determining whether the input image signals are repeated by comparing the stored input image signals for each pixel;
generating a compensation image signal for the pixel where the input image signals are repeated during a plurality of continuous frames; and
generating a data signal corresponding to the compensation image signal and supplying the data signal to the pixel.

9. The method of claim 8, wherein:
generating the compensation image signal comprises periodically inputting a black data signal to the input image signal.

10. The method of claim 9, further comprising, after inputting the black data signal: inputting the input image signal.

11. The method of claim 8, further comprising:
storing a location information and the input image signal of the repeated portion of pixels.

12. The method of claim 8, further comprising:
generating a data signal corresponding to the input image signal and supplying the data signal to the pixel where the input image signals are different during the continuous frames.

13. A display device, comprising:
a plurality of pixels for displaying images,
wherein, if image signals are repeated for a portion of pixels of the pixels during a plurality of frames,
a black data signal is periodically input to the portion of pixels after the image signal, and a normal image signal is input to the remaining pixels.

14. The display device of claim 13, wherein:
the portion of pixels is supplied with a normal image signal after being periodically supplied with the black data signal.

15. The display device of claim 1, wherein the light emitting elements are organic light emitting diodes.

16. The method of claim 8, wherein the light emitting elements are organic light emitting diodes.

17. The display device of claim 13, wherein the pixels comprise organic light emitting diodes.
